(19) United States
(12) Patent Application Publication
(10) Pub. No.: US 2015/0052998 A1
(43) Pub. Date: Feb. 26, 2015

(54) ANGULAR VELOCITY SENSOR

(71) Applicant: SAMSUNG ELECTRO-MECHANICS CO., LTD., SUWON-SI (KR)

(72) Inventors: Won HAN, Suwon-si (KR); Jong Woon KIM, Suwon-Si (KR); Yu Heon YI, Suwon-si (KR)

(73) Assignee: SAMSUNG ELECTRO-MECHANICS CO., LTD., SUWON-SI (KR)

(21) Appl. No.: 14/249,024

(22) Filed: Apr. 9, 2014

(30) Foreign Application Priority Data
Aug. 21, 2013 (KR) 10-2013-0099331

(51) Int. Cl. G01P 3/14

(52) U.S. Cl. CPC G01P 3/14
USPC 73/504.12

(57) ABSTRACT

Disclosed herein is an angular velocity sensor including: a mass body part including a plurality of mass bodies; an internal frame supporting the mass body part; a flexible part for sensing connecting the mass body part to the internal frame so that the mass body part is rotatable and provided with a sensing unit; an external frame supporting the internal frame; and a flexible part for vibrating connecting the internal frame to the external frame so that the internal frame is rotatable and provided with a driving unit, wherein the flexible part for vibrating provided with the driving unit is disposed at an outer side of the internal frame in a displacement direction of the mass body part depending on rotation of the mass body part.

### CROSS REFERENCE TO RELATED APPLICATION

This application claims the benefit of Korean Patent Application No. 10-2013-0099331, filed on Aug. 21, 2013, entitled “Angular Velocity Sensor”, which is hereby incorporated by reference in its entirety into this application.

### BACKGROUND OF THE INVENTION

1. Technical Field

The present invention relates to an angular velocity sensor.

2. Description of the Related Art

Recently, an angular velocity sensor has been used in various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The angular velocity sensor generally adopts a configuration in which a mass body is adhered to an elastic substrate such as a membrane, or the like, in order to measure an angular velocity. Through the configuration, the angular velocity sensor may calculate the angular velocity by measuring Coriolis force applied to the mass body.

In detail, a scheme of measuring the angular velocity using the angular velocity sensor is as follows. First, the angular velocity may be measured by Coriolis force “F=2mΩv”, where “F” represents the Coriolis force acting on the mass body, “m” represents the mass of the mass body, “Ω” represents the angular velocity to be measured, and “v” represents the motion velocity of the mass body. Among others, since the motion velocity v of the mass body and the mass m of the mass body are values known in advance, the angular velocity Ω may be obtained by detecting the Coriolis force (F) acting on the mass body.

Meanwhile, the angular velocity sensor according to the prior art includes a piezoelectric material disposed on a membrane (a diaphragm) in order to drive a mass body or sense displacement of the mass body, as disclosed in the following Prior Art Document (Patent Document). In order to measure the angular velocity using the angular velocity sensor, it is preferable to allow a resonant frequency of a driving mode and a resonant frequency of a sensing mode to substantially coincide with each other. However, very large interference occurs between the driving mode and the sensing mode due to a fine manufacturing error caused by a shape, stress, a physical property, or the like. Therefore, since a noise signal significantly larger than an angular velocity signal is output, circuit amplification of the angular velocity signal is limited, such that sensitivity of the angular velocity sensor is deteriorated.

### PRIOR ART DOCUMENT

### Patent Document

(Patent Document 1) US20110146404 A1

### SUMMARY OF THE INVENTION

The present invention has been made in an effort to provide a driving part integrated type angular velocity sensor capable of removing interference between a driving mode and a sensing mode and decreasing an effect due to a manufacturing error by driving a frame and a mass body by a single driving part to individually generate driving displacement and sensing displacement of the mass body and forming flexible parts so that the mass body is movable only in a specific direction.

Further, the present invention has been made in an effort to provide an angular velocity sensor capable of improving sensitivity by maximizing a mass body part in a limited region due to an optimal structure.

According to a preferred embodiment of the present invention, there is provided an angular velocity sensor including: a mass body part including a plurality of mass bodies; an internal frame supporting the mass body part; a flexible part for sensing connecting the mass body part to the internal frame so that the mass body part is rotatable and provided with a sensing unit; an external frame supporting the internal frame; and a flexible part for vibrating connecting the internal frame to the external frame so that the internal frame is rotatable and provided with a driving unit, wherein the flexible part for vibrating provided with the driving unit is disposed at an outer side of the internal frame in a displacement direction of the mass body part depending on rotation of the mass body part.

A connection direction in which the flexible part for sensing provided with the sensing unit connects the mass body and the internal frame to each other may be in parallel with a connection direction in which the flexible part for vibrating provided with the driving unit connects the internal frame and the external frame to each other.

The flexible part for sensing may include first and second flexible parts connecting the mass body part to the internal frame, respectively, wherein the first and second flexible parts may be disposed in a direction in which they are perpendicular to each other.

The first flexible part may be a beam having a surface formed by one axis direction and the other axis direction and a thickness extended in a direction perpendicular to the surface.

The first flexible part may be a beam having a predetermined thickness in a Z axis direction and a surface formed by X and Y axes and have a width W₁ in an X axis direction larger than a thickness T₁ in the Z axis direction.

The second flexible part may be a hinge having a thickness in one axis direction and a surface formed in the other axis direction.

The second flexible part may be a hinge having a predetermined thickness in a Y axis direction and a surface formed in X and Z axes and have a width W₂ in a Z axis direction larger than a thickness T₂ in the Y axis direction.

One surfaces of the first and second flexible parts may be individually or selectively provided with the sensing unit sensing a displacement of the mass body.

The flexible part for vibrating may include third and fourth flexible parts connecting the internal frame to the external frame, respectively, and a connection direction in which the third flexible part connects the internal frame to the external frame and a connection direction in which the fourth flexible part connects the internal frame to the external frame may be in parallel with each other.

The third flexible part may be a beam having a surface formed by one axis direction and the other axis direction and a thickness extended in a direction perpendicular to the surface.

The third flexible part may be a beam having a predetermined thickness in a Z axis direction and a surface formed by X and Y axes and have a width W₃ in an X axis direction larger than a thickness T₃ in the Z axis direction.

The fourth flexible part may be a hinge having a thickness in one axis direction and a surface formed in the other axis direction.

The fourth flexible part may be a hinge having a predetermined thickness in an X axis direction and a surface formed in Y and Z axes and have a width W₄ in a Z axis direction larger than a thickness T₄ in the X axis direction.

The fourth flexible part may be connected to a central portion of the internal frame, and the internal frame may be rotated so that a symmetrical displacement is generated based on the fourth flexible part.

One surfaces of the third and fourth flexible parts may be individually or selectively provided with the driving unit driving the internal frame.

The mass body part may include first and second mass bodies disposed to be symmetrical to each other.

The first and second mass bodies supported by the internal frame may be disposed to be symmetrical to each other based on the fourth flexible part connected to the internal frame.

The internal frame may include protrusion coupling parts protruding toward the external frame so that the flexible parts for sensing provided with the sensing unit are connected thereto.

The protrusion coupling parts may be formed at both end portions of the internal frame so as to be extended in an X axis, and flexible parts for sensing may be coupled to the protrusion coupling parts in a Y axis direction.

According to another preferred embodiment of the present invention, there is provided an angular velocity sensor including: a mass body part including a plurality of mass bodies; an internal frame supporting the mass body part; a flexible part for sensing connecting the mass body part to the internal frame so that the mass body part is rotatable and provided with a sensing unit; an external frame supporting the internal frame; and a flexible part for vibrating connecting the internal frame to the external frame so that the internal frame is rotatable and provided with a driving unit, wherein the flexible part for sensing provided with the sensing unit is disposed at an outer side in a displacement direction of the mass body part depending on rotation of the mass body part.

A connection direction in which the flexible part for sensing provided with the sensing unit connects the mass body and the internal frame to each other may be in parallel with a connection direction in which the flexible part for vibrating provided with the driving unit connects the internal frame and the external frame to each other.

The internal frame may include protrusion coupling parts protruding toward the external frame so that the flexible parts for sensing provided with the sensing unit are connected thereto, the external frame may include coupling protrusion parts formed so as to be in parallel with the protrusion coupling parts of the internal frame, and one end of the flexible part for vibrating provided with the driving unit may be connected to the protrusion coupling part and the other end thereof may be connected to the coupling protrusion part.

The flexible part for sensing may include first and second flexible parts connecting the mass body part to the internal frame, respectively, and a connection direction in which the first flexible part connects the internal frame to the mass body part may be in parallel with a connection direction in which the second flexible part connects the internal frame to the mass body part.

Each of the first and second flexible parts connects the mass body part to the internal frame in an X axis direction, and the mass body part may have the first flexible parts connected to both end portions thereof, respectively, and the second flexible parts connected to central portions thereof, respectively, in a Y axis direction.

The flexible part for vibrating may include third and fourth flexible parts connecting the internal frame to the external frame, respectively, and a connection direction in which the third flexible part connects the internal frame to the external frame and a connection direction in which the fourth flexible part connects the internal frame to the external frame may be perpendicular to each other.

According to still another preferred embodiment of the present invention, there is provided an angular velocity sensor including: a mass body part including a plurality of mass bodies; an internal frame supporting the mass body part; a flexible part for sensing connecting the mass body part to the internal frame so that the mass body part is rotatable and provided with a sensing unit; an external frame supporting the internal frame; and a flexible part for vibrating connecting the internal frame to the external frame so that the internal frame is rotatable and provided with a driving unit, wherein the flexible part for vibrating provided with the driving unit is disposed at an outer side in a displacement direction of the mass body part depending on rotation of the mass body part, and the flexible part for sensing provided with the sensing unit is disposed at the outer side in the displacement direction of the mass body part depending on the rotation of the mass body part.

A connection direction in which the flexible part for sensing provided with the sensing unit connects the mass body part and the internal frame to each other may be perpendicular to a connection direction in which the flexible part for vibrating provided with the driving unit connects the internal frame and the external frame to each other.

The flexible part for sensing may include first and second flexible parts connecting the mass body part to the internal frame, respectively, and a connection direction in which the first flexible part connects the internal frame to the mass body part may be in parallel with a connection direction in which the second flexible part connects the internal frame to the mass body part.

Each of the first and second flexible parts may connect the mass body part to the internal frame in an X axis direction, and the mass body part may have the first flexible parts connected to both end portions thereof, respectively, and the second flexible parts connected to central portions thereof, respectively, in a Y axis direction.

The flexible part for vibrating may include third and fourth flexible parts connecting the internal frame to the external frame, respectively, and a connection direction in which the third flexible part connects the internal frame to the external frame and a connection direction in which the fourth flexible part connects the internal frame to the external frame may be in parallel with each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing an angular velocity sensor according to a first preferred embodiment of the present invention;

FIG. 2 is a plan view of the angular velocity sensor shown in FIG. 1;

FIG. 3 is a schematic cross-sectional view of the angular velocity sensor taken along the line A-A of FIG. 2;

FIG. 4 is a schematic cross-sectional view of the angular velocity sensor taken along the line B-B of FIG. 2;

FIG. 5 is a schematic cross-sectional view of the angular velocity sensor taken along the line C-C of FIG. 2;

FIG. 6 is a plan view showing movable directions of a mass body part and an internal frame in the angular velocity sensor shown in FIG. 2;

FIGS. 7A and 7B are cross-sectional views showing a process in which a mass body part shown in FIG. 4 is rotated with respect to an internal frame;

FIGS. 8A and 8B are cross-sectional views showing a process in which an internal frame shown in FIG. 3 is rotated based on an external frame;

FIG. 9 is a perspective view schematically showing an angular velocity sensor according to a second preferred embodiment of the present invention;

FIG. 10 is a schematic plan view of the angular velocity sensor shown in FIG. 9;

FIG. 11 is a schematic cross-sectional view of the angular velocity sensor taken along the line A-A of FIG. 9;

FIG. 12 is a schematic cross-sectional view of the angular velocity sensor taken along the line B-B of FIG. 9;

FIG. 13 is a schematic cross-sectional view of the angular velocity sensor taken along the line C-C of FIG. 9; and

FIG. 14 is a plan view schematically showing an angular velocity sensor according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

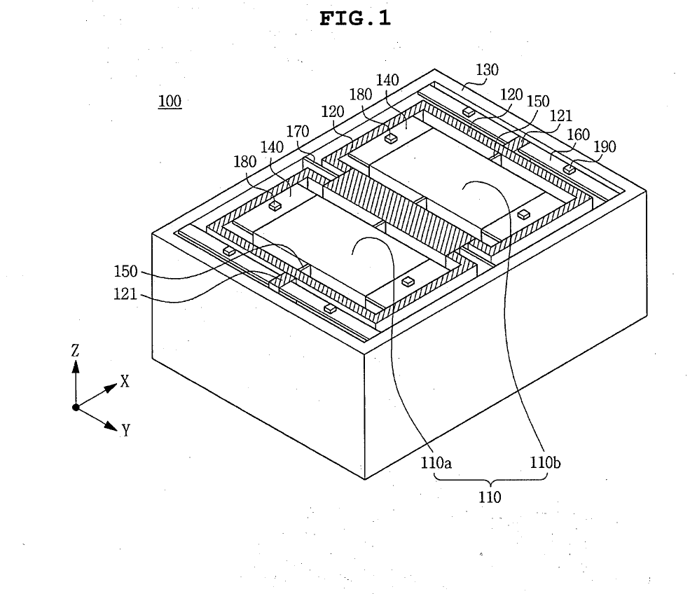

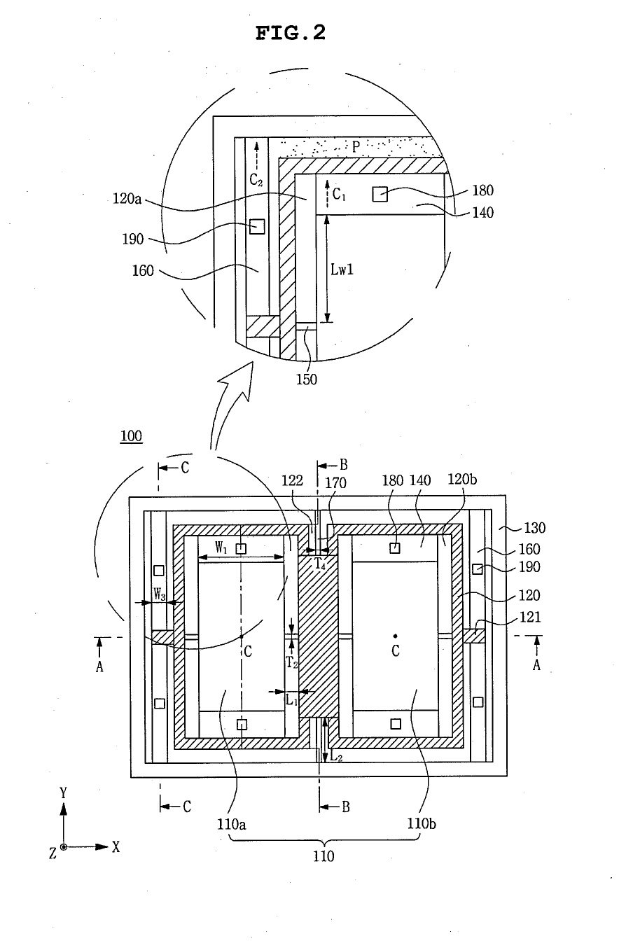

FIG. 1 is a perspective view schematically showing an angular velocity sensor according to a first preferred embodiment of the present invention; and FIG. 2 is a plan view of the angular velocity sensor shown in FIG. 1.

As shown in FIGS. 1 and 2, the angular velocity sensor 100 is configured to include a mass body part 110, an internal frame 120, an external frame 130, first flexible parts 140, second flexible parts 150, third flexible parts 160, and fourth flexible parts 170.

In addition, the first and second flexible parts 140 and 150, which are flexible parts sensing, are individually or selectively provided with a sensing unit 180, and the third and fourth flexible parts 160 and 170, which are flexible parts for vibrating, are individually or selectively provided with a driving unit 190.

Further, the third flexible part 160, which is the flexible part for vibrating provided with the driving unit 190 is disposed at an outer side of the internal frame 120 with respect to rotation of the mass body part 110. That is, a region P shown in an enlarged view of FIG. 2 is a region corresponding to displacement directions of the third flexible part 160 and the first flexible part 140 depending on the rotation of the mass body part 110.

As described above, since the third flexible part 160 is disposed at the outer side of the internal frame 120 with respect to the rotation of the mass body part 110, the third flexible part 160 is significantly deformed in the displacement direction (a Y axis direction), thereby making it possible to significantly rotate the internal frame 120, and since a maximum length Lw1 of the mass body part 110 from the center of rotation is secured, the mass body 110 may secure a large mass, thereby making it possible to improve sensing sensibility.

In addition, a connection direction in which the flexible part for sensing provided with the sensing unit 180 connects the mass body part and the internal frame to each other may be in parallel with a connection direction in which the flexible part for vibrating provided with the driving unit 190 connects the internal frame and the external frame to each other.

That is, the first flexible part 140, which is the flexible part for sensing provided with the sensing unit 180 connects the mass body part 110 and the internal frame 120 to each other in a C1 direction corresponding to the Y axis direction and the third flexible part 160 provided with the driving unit 190 connects the internal frame 120 and the external frame 130 to each other in a C2 direction corresponding to the Y axis direction, such that the C1 direction corresponding to the connection direction of the first flexible part 140 and the C2 direction corresponding to the connection direction of the third flexible part 160 are in parallel with each other.

Next, the mass body 110, which is displaced by Coriolis force, includes a first mass body 110a and a second mass body 110b.

In addition, the first and second mass bodies 110a and 110b may have the same size and be disposed to be symmetrical to each other.

Further, the first and second mass bodies 110a and 110b are connected to the internal frame 120 by the first and second flexible parts 140 and 150.

In addition, the first and second mass bodies 110a and 110b are displaced based on the internal frame 120 by bending of the first flexible part 140 and twisting of the second flexible part 150 when Coriolis force acts thereon. Here, the first and second mass bodies 110a and 110b are rotated based on an X axis with respect to the internal frame 120. A detailed content associated with this will be described below.

Meanwhile, although the case in which the first and second mass bodies 110a and 110b have a generally square pillar shape is shown, the first and second mass bodies 110a and 110b are not limited to having the above-mentioned shape, but may have all shapes known in the art.

In addition, the first and second mass bodies 110a and 110b positioned in the internal frame 120 are disposed to be symmetrical to each other based on the fourth flexible part 170 connected to the internal frame 120.

Further, the internal frame 120 supports the mass body part 110. More specifically, the internal frame 120 may have the first and second mass bodies 110a and 110b positioned therein and be connected to the mass body part 110 by the first and second flexible parts 140 and 150. That is, the internal frame 120 allows a space in which the mass body part 110 may be displaced to be secured and becomes a basis when the mass body part 110 is displaced. In addition, the internal frame 120 may also cover only a portion of the mass body part 110.

Further, the internal frame 120 may be divided into two space parts 120a and 120b so that the first and second mass bodies 110a and 110b are positioned therein. In addition, the internal frame 120 may have a square pillar shape in which it has a square pillar shaped cavity formed at the center thereof, but is not limited thereto.

Further, the internal frame 120 may include protrusion coupling parts 121 protruding toward the external frame so that the third flexible part 160, which is the flexible part for vibrating, is connected thereto.

In addition, the protrusion coupling parts 121 protrude so that the internal frame 120 and the external frame 130 are connected to each other in the Y axis direction by the third flexible part 160 and are formed at both end portions of the internal frame 120 in the X axis direction so as to be extended in the X axis direction. Therefore, one end of the third flexible part 160 is coupled to the protrusion coupling part 121 of the internal frame and the other end thereof is coupled to the external frame 130. That is, since the internal frame 120 should be rotated based on the fourth flexible part 170, the protrusion coupling part 121 is not connected to the external frame 130.

Next, the external frame 130 supports the internal frame 120. More specifically, the external frame 130 is provided at the outer side of the internal frame 120 so as to be spaced apart from the internal frame 120 and is connected to the internal frame 120 by the third and fourth flexible parts 160 and 170. Therefore, the internal frame 120 and the mass body part 110 connected to the internal frame 120 are supported by the external frame 130 in a floated state so as to be displaceable. In addition, the external frame 130 may also cover only a portion of the internal frame 120.

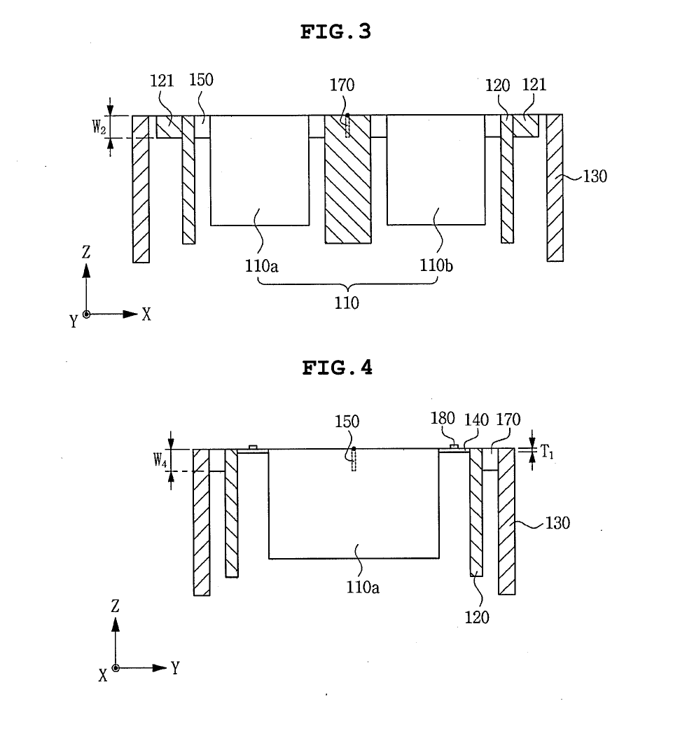

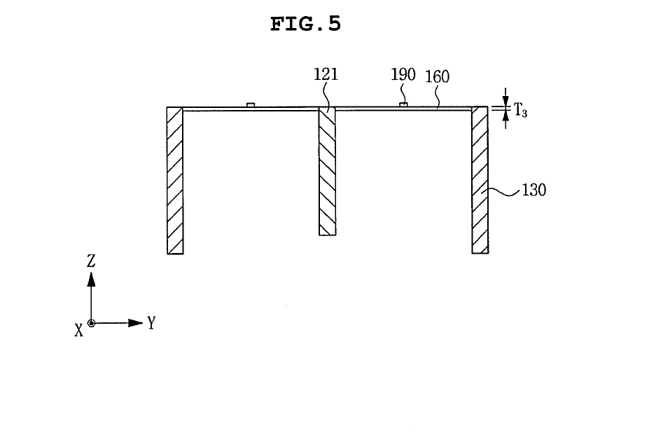

FIG. 3 is a schematic cross-sectional view of the angular velocity sensor taken along the line A-A of FIG. 2; FIG. 4 is a schematic cross-sectional view of the angular velocity sensor taken along the line B-B of FIG. 2; and FIG. 5 is a schematic cross-sectional view of the angular velocity sensor taken along the line C-C of FIG. 2.

Hereinafter, structural features, shapes, and organic couplings of the respective components of the angular velocity sensor 100 according to the first preferred embodiment of the present invention will be described in detail with reference to FIGS. 1 to 5.

First, both end portions of the first and second mass bodies 110a and 110b of the mass body part 110 in the Y axis direction are connected to the internal frame 120 by the first flexible parts 140, respectively, and both end portions of the first and second mass bodies 110a and 110b of the mass body part 110 in the X axis direction are connected to the internal frame 120 by the second flexible parts 150, respectively. Here, the first and second mass bodies 110a and 110b have the second flexible parts 150 connected thereto at central portions thereof in the Y axis direction. Therefore, the first and second mass bodies 110a and 110b have the second flexible parts connected thereto so as to correspond to the centers of gravity thereof, respectively, and may be symmetrically moved by the second flexible parts, respectively, in the case in which they are rotated based on the second flexible parts, respectively.

In addition, the first flexible part 140 is a beam having a predetermined thickness in a Z axis direction and having a surface formed by X and Y axes. That is, the first flexible part has a width W₁ in the X axis direction larger than a thickness T₁ in the Z axis direction.

Further, in the Y axis direction, one end of the first flexible part 140 is connected to the mass body part 110 and the other end thereof is connected to the internal frame 120. To this end, the first flexible part 140 is extended in the Y axis direction.

In addition, the first flexible part 140 may be provided with the sensing unit 180. That is, when viewed based on an XY plane, the first flexible part 140 is relatively wider than the second flexible part 150. Therefore, the first flexible part 140 may be provided with the sensing unit 180 sensing displacements of the first and second mass bodies 110a and 110b.

In addition, the sensing unit 180 may be formed so as to use a piezoelectric scheme, a piezoresistive scheme, a capacitive scheme, an optical scheme, or the like, but is not particularly limited thereto.

Further, the second flexible part 150 is a hinge having a predetermined thickness in the Y axis direction and having a surface formed by the X and Y axes. That is, the second flexible part 150 may have a width W₂ in the Z axis direction larger than a thickness T₂ in the Y axis direction.

In addition, the first and second flexible parts 140 and 150 are disposed in a direction in which they are perpendicular to each other. That is, the first flexible part 140 is coupled to the mass body part 110 and the internal frame 120 in the Y axis direction, and the second flexible part 150 is coupled to the mass body part 110 and the internal frame 120 in the X axis direction.

As described above, since the second flexible part 150 has the width W₂ in the Z axis direction larger than the thickness T₂ in the Y axis direction, the first and second mass bodies 110a and 110b are limited from being rotated based on the Y axis or translated in the Z axis direction, but may be relatively freely rotated based on the X axis. That is, the first and second mass bodies 110a and 110b are positioned in the internal frame 120 to thereby be rotated based on the X axis direction, and the second flexible part 150 serves as a hinge to this end.

In addition, the third flexible part 160 is a beam having a predetermined thickness in the Z axis direction and having a surface formed by the X and Y axes. That is, the third flexible part 160 has a width W₃ in the X axis direction larger than a thickness T₃ in the Z axis direction. Further, in the Y axis direction, one end of the third flexible part 160 is connected to the internal frame and the other end thereof is connected to the external frame. To this end, the third flexible part 160 is extended in the Y axis direction.

Therefore, the third flexible part 160 and the first flexible part 140 are extended in the Y axis direction and are disposed in parallel with each other.

Further, the fourth flexible part 170 is a hinge having a predetermined thickness in the X axis direction and having a surface formed by the Y and Z axes. That is, the fourth flexible part 170 may have a width W₄ in the Z axis direction larger than a thickness T₄ in the X axis direction. Therefore, the internal frame 120 is limited from being rotated based on the X axis or translated in the Z axis direction, but may be relatively freely rotated based on the Y axis. That is, the internal frame 120 is fixed to the external frame 130 to thereby be rotated based on the Y axis direction, and the fourth flexible part 170 serves as a hinge to this end.

In addition, the fourth flexible part 170 is coupled to a central portion between two space parts 120a and 120b of the internal frame. Further, in order to provide larger flexibility, a coupling groove part 122 is formed in the internal frame, and the fourth flexible part 170 may be inserted into and coupled to the coupling groove part 122.

That is, the fourth flexible part 170 is connected to the coupling groove part 122 formed at a central portion of the internal frame 120, and the internal frame 120 is rotated so that a symmetrical displacement is generated based on the fourth flexible part 170.

In addition, the third and fourth flexible parts 160 and 170 are disposed so that directions in which they are extended, that is, directions in which they connect the internal frame 120 to the external frame 130 are in parallel with each other.

That is, the third flexible part 160 is coupled to the internal frame 120 and the external frame 130 in the Y axis direction, and the fourth flexible part 170 is coupled to the internal frame 120 and the external frame 130 in the Y axis direction.

In addition, as described above, one end of the third flexible part 160 is coupled to the protrusion coupling part 121 of the internal frame and the other end thereof is coupled to the external frame 130.

Therefore, the internal frame 120 may be displaced in a state in which it is supported to the external frame 130 by the third and fourth flexible parts 160 and 170.

In addition, the third and fourth flexible parts 160 and 170 may be selectively provided with the driving unit 190. Here, the driving unit 190, which is to drive the internal frame 120 and the mass body part 110, may use a piezoelectric scheme, a capacitive scheme, or the like. In addition, when viewed based on the XY plane, the third flexible part 160 is relatively wider than the fourth flexible part 170. Therefore, the third flexible part 160 may be provided with the driving unit 190 driving the internal frame 120.

Here, the driving unit 190 may drive the internal frame 120 so as to be rotated based on the Y axis. Here, the driving unit 190 may use a piezoelectric scheme, a capacitive scheme, or the like, but is not particularly limited thereto.

In addition, the first to fourth flexible parts 140 to 170 are disposed as described above, such that the connection direction C1 in which the first flexible part 140 connects the mass body part 110 and the internal frame 120 to each other is in parallel with the connection direction C2 in which the third flexible part connects the internal frame 120 and the external frame 130 to each other.

Further, the second and fourth flexible parts 150 and 170 are disposed in a direction in which they are perpendicular to each other.

Further, the second and fourth flexible parts 150 and 170 of the angular velocity sensor according to the preferred embodiment of the present invention may have all possible shapes such as a hinge shape having a rectangular cross section, a torsion bar shape having a circular cross section, or the like.

Through the configuration as described above, in the angular velocity sensor according to the first preferred embodiment of the present invention, the third flexible part 160 is disposed at the outer side of the internal frame in the displacement direction of the mass body part depending on the rotation of the mass body part, such that a size of the internal frame positioned in the external frame may be maximized in the Y axis direction. Therefore, the mass body part may be designed at a maximum size in the Y axis direction when it is formed.

That is, since the mass body part is rotated based on the X axis and is rotation-displaced in the Y axis direction, a size of the mass body part in the Y axis direction as large as possible should be secured in order to generate a maximum displacement. In this case, sensing sensitivity is improved. Therefore, the angular velocity sensor according to the first preferred embodiment of the present invention may improve the sensing sensitivity through optimal structures and organic couplings of the third flexible part 160, the internal frame 120, and the external frame 130 described above.

Hereinafter, movable directions and driving examples of the mass body and the internal frame in the angular velocity sensor according to the first preferred embodiment of the present invention will be described in more detail with reference to the accompanying drawings.

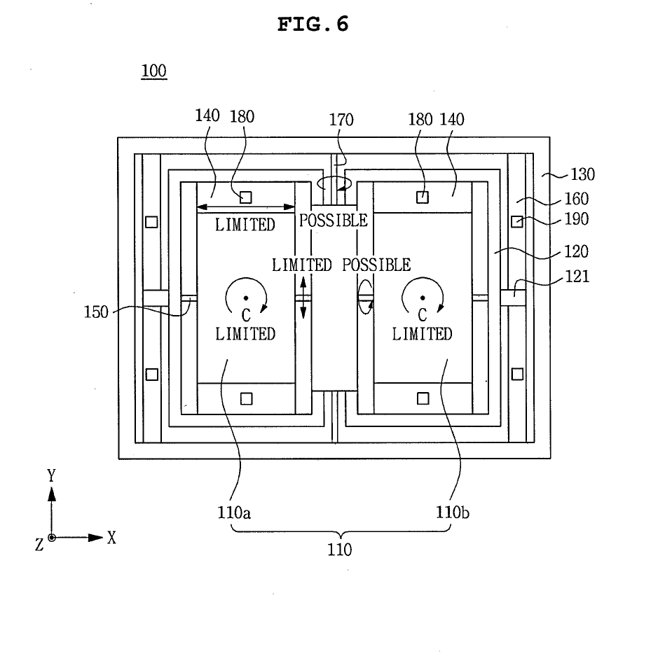

FIG. 6 is a plan view showing movable directions of a mass body part and an internal frame in the angular velocity sensor shown in FIG. 2.

First, relationships among the width W₂ of the second flexible part 150 in the Z axis direction, a length L₁ thereof in the X axis direction, the thickness T₂ thereof in the Y axis direction, and rigidities thereof in each direction may be represented by the following Equations.

(1) The rigidity of the second flexible part 150 at the time of the rotation based on the Y axis or the rigidity thereof at the time of the translation in the Z axis direction ∝W₂³×T₂/L₁³

(2) The rigidity of the second flexible part 150 at the time of the rotation based on the X axis ∝T₂³W₂/L₁

According to the above two Equations, the value of (the rigidity of the second flexible part 150 at the time of the rotation based on the Y axis or the rigidity of the second flexible part 150 at the time of the translation in the Z axis direction)/(the rigidity of the second flexible part 150 at the time of the rotation based on the X axis) is in proportion to (W₂/(T₂L₁))².

However, since the second flexible part 150 according to the present embodiment has the width W2 in the Z axis direction larger than the thickness T₂ in the Y axis direction, (W₂/(T₂L₁))² is large, such that the value of (the rigidity of the second flexible part 150 at the time of the rotation based on the Y axis or the rigidity of the second flexible part 150 at the time of the translation in the Z axis direction)/(the rigidity of the second flexible part 150 at the time of the rotation based on the X axis) increases. Due to these characteristics of the second flexible part 150, the first and second mass bodies 110a and 110b are freely rotated based on the X axis, but are limited from being rotated based on the Y axis or translated in the Z axis direction, with respect to the internal frame 120.

Meanwhile, the first flexible part 140 has relatively very high rigidity in the length direction (the Y axis direction), thereby making it possible to limit the first and second mass bodies 110a and 110b from being rotated based on the Z axis or translated in the Y axis direction, with respect to the internal frame 120.

In addition, the second flexible part 150 has relatively very high rigidity in the length direction (the X axis direction), thereby making it possible to limit the first and second mass bodies 110a and 110b from being translated in the X axis direction, with respect to the internal frame 120.

As a result, due to the characteristics of the first and second flexible parts 140 and 150 described above, the first and second mass bodies 110a and 110b may be rotated based on the X axis, but are limited from being rotated based on the Y or Z axis or translated in the Z, Y, or X axis direction, with respect to the internal frame 120. That is, the movable directions of the first and second mass bodies 110a and 110b may be represented by the following Table 1.

TABLE 1

| Movable directions of first and second | Whether or not |
|---|---|
| mass bodies (based on internal frame) | movement is possible |
| Rotation based on X axis | Possible |
| Rotation based on Y axis | Limited |
| Rotation based on Z axis | Limited |
| Translation in X axis direction | Limited |
| Translation in Y axis direction | Limited |
| Translation in Z axis direction | Limited |

As described above, since the first and second mass bodies 110a and 110b may be rotated based on the X axis, that is, the second flexible part 150, but are limited from being moved in the remaining directions, with respect to the internal frame 120, the first and second mass bodies 110a and 110b may be allowed to be displaced only with respect to force in a desired direction (the rotation based on the X axis).

Next, since the fourth flexible part 170 has a width W₄ in the Z axis direction larger than a thickness T₄ in the X axis direction, the internal frame 120 is limited from being rotated based on the X axis or translated in the Y axis direction, but is relatively freely rotated based on the Y axis.

More specifically, in the case in which rigidity of the fourth flexible part 170 at the time of rotation based on the X axis is larger than rigidity of the fourth flexible part 170 at the time of rotation based on the Y axis, the internal frame 120 may be freely rotated based on the Y axis, but is limited from being rotated based on the X axis. Similarly, in the case in which rigidity of the fourth flexible part 170 at the time of translation in the Z axis direction is larger than the rigidity of the fourth flexible part 170 at the time of the rotation based on the Y axis, the internal frame 120 may be freely rotated based on the Y axis, but is limited from being translated in the Z axis direction.

Therefore, as a value of (the rigidity of the fourth flexible part 170 at the time of the rotation based on the X axis or the rigidity of the fourth flexible part 170 at the time of the translation in the Z axis direction)/(the rigidity of the fourth flexible part 170 at the time of the rotation based on the Y axis) increases, the internal frame 120 is freely rotated based on the Y axis, but is limited from being rotated based on the X axis or translated in the Z axis direction, with respect to the external frame 130.

First, relationships among the width W₄ of the fourth flexible part 170 in the Z axis direction, a length L₂ thereof in the Y axis direction, the thickness T₄ thereof in the X axis direction, and rigidities thereof in each direction may be represented by the following Equations.

(1) The rigidity of the fourth flexible part 170 at the time of the rotation based on the X axis or the rigidity thereof at the time of the translation in the Z axis direction ∝T₄×W₄³/L₂³

(2) The rigidity of the fourth flexible part 170 at the time of the rotation based on the Y axis ∝T₄³×W₄/L₂

According to the above two Equations, the value of (the rigidity of the fourth flexible part 170 at the time of the rotation based on the X axis or the rigidity of the fourth flexible part 170 at the time is of the translation in the Z axis direction)/(the rigidity of the fourth flexible part 170 at the time of the rotation based on the Y axis) is in proportion to (W₄/(T₄L₂))².

However, since the fourth flexible part 170 has the width W₄ in the Z axis direction larger than the thickness T₄ in the X axis direction, (W₄/(T₄L₂))² is large, such that the value of (the rigidity of the fourth flexible part 170 at the time of the rotation based on the X axis or the rigidity of the fourth flexible part 170 at the time of the translation in the Z axis direction)/(the rigidity of the fourth flexible part 170 at the time of the rotation based on the Y axis) increases. Due to these characteristics of the fourth flexible part 170, the internal frame 120 is rotated based on the Y axis, but is limited from being rotated based on the X axis or translated in the Z axis direction, with respect to the external frame 130.

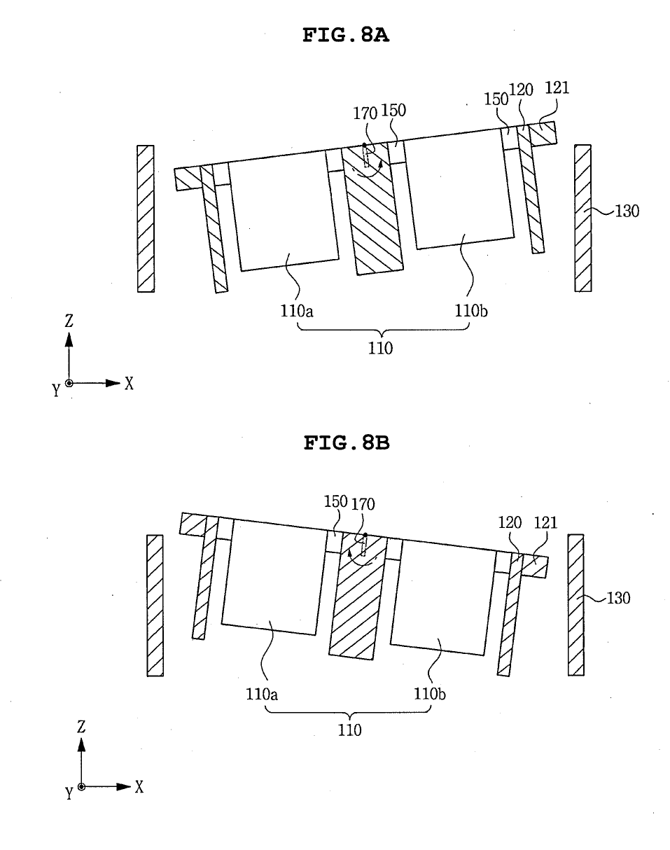

Meanwhile, the third flexible part 160 has relatively very high rigidity in the length direction (the Y axis direction), thereby making it possible to limit the internal frame 120 from being rotated based on the Z axis or translated in the Z axis direction, with respect to the external frame 130. In addition, the fourth flexible part 170 has relatively very high rigidity in the length direction (the Y axis direction), thereby making it possible to limit the internal frame 120 from being translated in the Y axis direction, with respect to the external frame 130 (See FIG. 8).

As a result, due to the characteristics of the third and fourth flexible parts 160 and 170 described above, the internal frame 120 may be rotated based on the Y axis, but are limited from being rotated based on the X or Z axis or translated in the Z, Y, or X axis direction, with respect to the external frame 130. That is, the movable directions of the internal frame 120 may be represented by the following Table 2.

TABLE 2

| Movable direction of internal | Whether or not |
|---|---|
| frame (based on external frame) | movement is possible |
| Rotation based on X axis | Limited |
| Rotation based on Y axis | Possible |
| Rotation based on Z axis | Limited |
| Translation in X axis direction | Limited |
| Translation in Y axis direction | Limited |
| Translation in Z axis direction | Limited |

As described above, since the internal frame 120 may be rotated based on the Y axis, but is limited from being moved in the remaining directions, with respect to the external frame 130, the internal frame 120 may be allowed to be displaced only with respect to force in a desired direction (the rotation based on the Y axis).

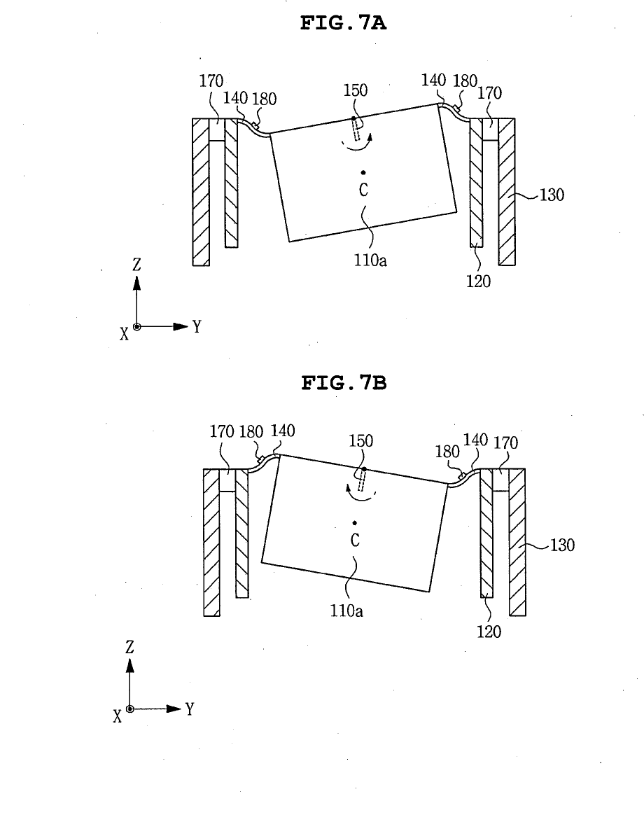

FIGS. 7A and 7B are cross-sectional views showing a process in which a mass body part shown in FIG. 4 is rotated with respect to an internal frame.

As shown in FIGS. 7A and 7B, since the first mass body 110a of the mass body part 110 is rotated based on the X axis as a rotation axis R with respect to the internal frame 120, that is, since the first mass body 110a is rotated based on an axis on which the second flexible part 150 is coupled thereto with respect to the internal frame, bending stress in which compression stress and tension stress are combined with each other is generated in the first flexible part 140, and twisting stress is generated based on the X axis in the second flexible part 150.

In this case, in order to generate a torque in the first mass body 110a, the second flexible part 150 may be disposed over the center C of gravity of the first mass body 110a based on the Z axis direction.

Meanwhile, as shown in FIG. 2, the second flexible part 150 is disposed at a position corresponding to the center C of gravity of the first mass body 110a based on the X axis direction so that the first mass body 110a is rotated depending on a symmetrical displacement based on the X axis.

In addition, bending stress of the first flexible part 140 depending on rotation movement of the first mass body 110a is detected by the sensing unit 180.

FIGS. 8A and 8B are cross-sectional views showing a process in which an internal frame shown in FIG. 3 is rotated based on an external frame. As shown in FIGS. 8A and 8B, since the internal frame 120 is rotated based on the Y axis with respect to the external frame 130, that is, since the internal frame 120 is rotated based on the fourth flexible part 170 hinge-coupling the internal frame 120 to the external frame 130, bending stress in which compression stress and tension stress are combined with each other is generated in the third flexible part 160, and twisting stress is generated based on the Y axis in the fourth flexible part 170.

The angular velocity sensor according to the first preferred embodiment of the present invention is configured as described above. Hereinafter, an angular velocity measuring method by the angular velocity sensor 100 will be described in detail.

First, the internal frame 120 is rotated based on the Y axis with respect to the external frame 130 using the driving unit 190. Here, the first and second mass bodies 110a and 110b vibrate while being rotated together with the internal frame 120 based on the Y axis, and a displacement is generated in the first and second mass bodies 110a and 110b due to the vibrations.

More specifically, a displacement (+X, −Z) in a +X axis direction and a −Z axis direction is generated in the first mass body 110a and at the same time, a displacement (+X, +Z) in the +X axis direction and a +Z axis direction is generated in the second mass body 110b. Then, a displacement (−X, +Z) in a −X axis direction and the +Z axis direction is generated in the first mass body 110a and at the same time, a displacement (−X, −Z) in the −X axis direction and the −Z axis direction is generated in the second mass body 110b. Here, when an angular velocity rotated based on the X or Z axis is applied to the first and second mass bodies 110a and 110b, Coriolis force is generated.

The first and second mass bodies 110a and 110b are displaced while being rotated based on the X axis with respected to the internal frame 120 by the Coriolis force, and the sensing unit 180 senses the displacements of the first and second mass bodies 110a and 110b.

More specifically, when the angular velocity rotated based on the X axis is applied to the first and second mass bodies 110a and 110b, the Coriolis force is generated in a −Y axis and then generated in a +Y axis in the first mass body 110a, and the Coriolis force is generated in the +Y axis and then is generated in the −Y axis in the second mass body 110b.

Therefore, the first and second mass bodies 110a and 110b are rotated based on the X axis in directions opposite to each other, the sensing unit 180 may sense each of the displacements of the first and second mass bodies 110a and 110b to calculate the Coriolis force, and an angular velocity rotated based on the X axis may be measured through the Coriolis force.

Meanwhile, when signals each generated in the first flexible part 140 and the sensing unit 180 connected to both end portions of the first mass body 110a are defined as SY1 and SY2 and signals each generated in the first flexible part 140 and the sensing unit 180 connected to both end portions of the second mass body 110b are defined as SY3 and SY4, an angular velocity rotated based on the X axis may be calculated from (SY1−SY2)−(SY3−SY4). As described above, since the signals are differentially output between the first and second mass bodies 110a and 110b rotated in the directions opposite to each other, acceleration noise may be offset.

In addition, when the angular velocity rotated based on the Z axis is applied to the first and second mass bodies 110a and 110b, the Coriolis force is generated in the −Y axis and then generated in the +Y axis in the first mass body 110a, and the Coriolis force is generated in the +Y axis and then is generated in the −Y axis in the second mass body 110b. Therefore, the first and second mass bodies 110a and 110b are rotated based on the X axis in the same direction as each other, the sensing unit 180 may sense the displacements of the first and second mass bodies 110a and 110b to calculate the Coriolis force, and an angular velocity rotated based on the Z axis may be measured through the Coriolis force.

Here, when signals each generated in the first flexible part 140 and the sensing unit 180 connected to both end portions of the first mass body 110a are defined as SY1 and SY2 and signals each generated in the first flexible part 140 and the sensing unit 180 connected to both end portions of the second mass body 110b are defined as SY3 and SY4, an angular velocity rotated based on the Z axis may be calculated from (SY1−SY2)+(SY3−SY4).

In addition, an example of angular velocity calculation depending on this is as follows.

As described above, when the internal frame 120 is rotated based on the Y axis with respect to the external frame 130 by the driving unit 190, the first mass body 110a vibrates while being rotated together with the internal frame 120 based on the Y axis, and velocities (Vₓ, V_{z}) are generated in the X and Z axis directions in the first mass body 110a depending on the vibrations. Here, when an angular velocity (Ω_{z}, Ωₓ) based on the Z or X axis is applied to the first mass body 110a, Coriolis force (F_{y}) is generated in the Y axis direction.

The first mass body 110a is displaced while being rotated based on the X axis with respect to the internal frame 120 by the Coriolis force (F_{y}), and the sensing unit 180 senses the displacement of the first mass body 110a. In addition, the displacement of the first mass body 110a is sensed, thereby making it possible to calculate the Coriolis force (F_{y}).

Therefore, the angular velocity (Ωₓ) based on the X axis may be calculated through the Coriolis force (F_{y}) from F_{y}=2mV_{z}Ωₓ, and the angular velocity (Ω_{z}) based on the Z axis may be calculated through the Coriolis force (F_{y}) from F_{y}=2mVₓΩ_{z}.

As a result, in the angular velocity sensor 100 according to the first preferred embodiment of the present invention, the mass body part 110 and the internal frame are connected to the external frame so as to be displaceable only in a specific direction, such that sensing may be accurately performed and the angular velocity rotated based on the X or Z axis may be measured by the sensing unit 180.

Further, in the angular velocity sensor according to the first preferred embodiment of the present invention, the third flexible part 160 is disposed at the outer side of the internal frame in the displacement direction of the mass body part depending on the rotation of the mass body part, such that a size of the internal frame positioned in the external frame may be maximized in the Y axis direction. Therefore, the mass body part may be designed at a maximum size in the Y axis direction when it is formed, such that the sensing sensibility may be improved.

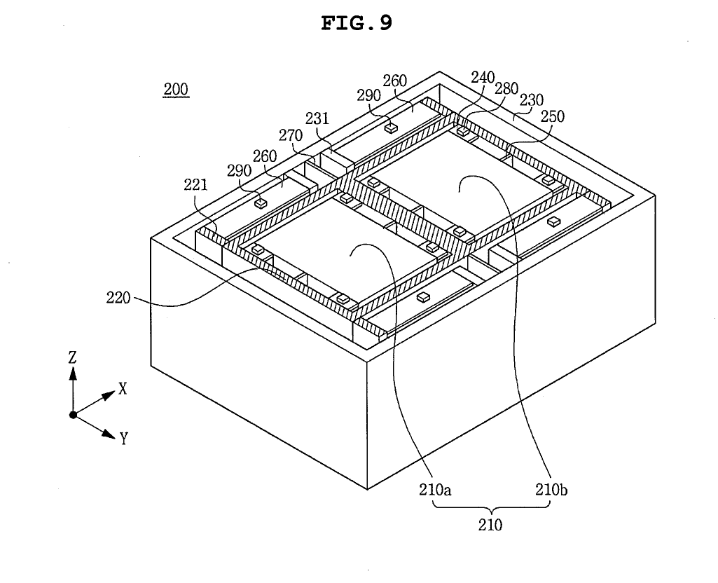

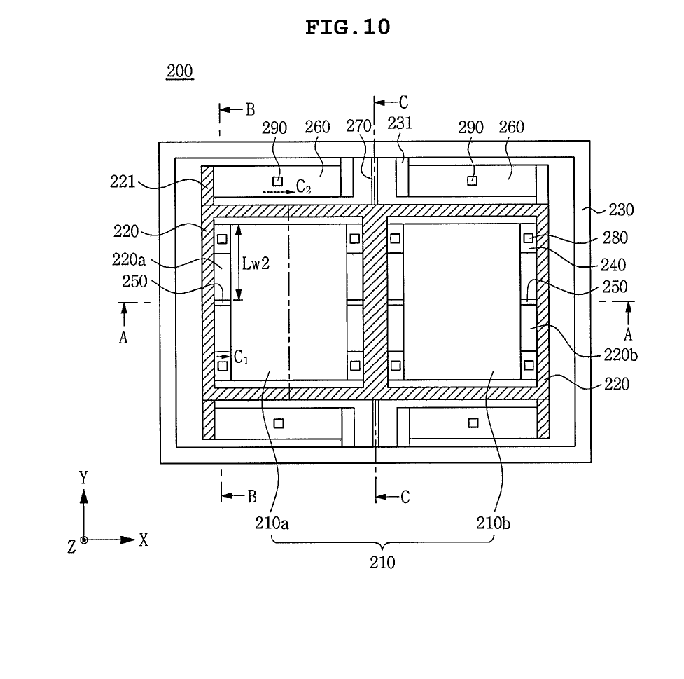

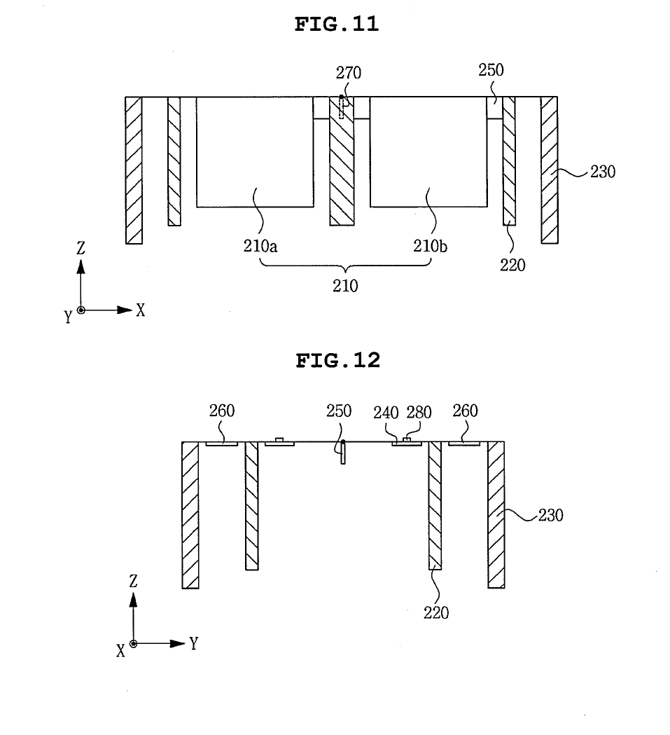

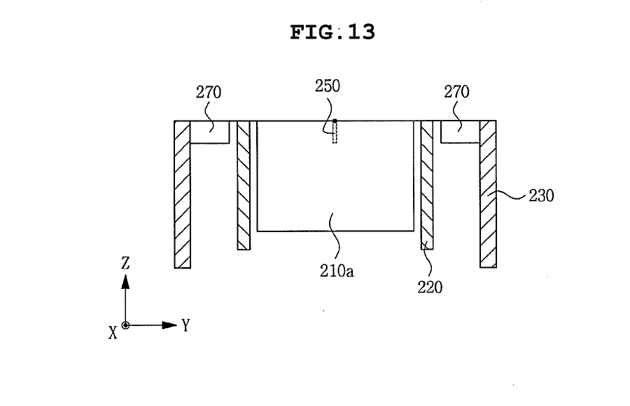

FIG. 9 is a perspective view schematically showing an angular velocity sensor according to a second preferred embodiment of the present invention; FIG. 10 is a schematic plan view of the angular velocity sensor shown in FIG. 9; FIG. 11 is a schematic cross-sectional view of the angular velocity sensor taken along the line A-A of FIG. 9; FIG. 12 is a schematic cross-sectional view of the angular velocity sensor taken along the line B-B of FIG. 9; and FIG. 13 is a schematic cross-sectional view of the angular velocity sensor taken along the line C-C of FIG. 9.

As shown in FIGS. 9 to 13, the angular velocity sensor 200 according to the second preferred embodiment of the present invention is different only in a mass body part, connection directions in which each of the first and third flexible parts connects a mass body part and an internal frame to each other or connects the internal frame and an external frame to each other and organic couplings for implementing this from the angular velocity sensor 100 according to the first preferred embodiment of the present invention. That is, in the angular velocity sensor 200 according to the second preferred embodiment of the present invention and the angular velocity sensor 100 according to the first preferred embodiment of the present invention, specific shapes of the respective components, generation of displacements depending on the specific shapes, and methods of sensing the displacements are the same as each other.

As shown in FIGS. 9 to 13, the angular velocity sensor 200 is configured to include a mass body part 210, an internal frame 220, an external frame 230, first flexible parts 240, second flexible parts 250, third flexible parts 260, and fourth flexible parts 270.

In addition, the first and second flexible parts 240 and 250, which are flexible parts for sensing, are individually or selectively provided with a sensing unit 280, and the third and fourth flexible parts 260 and 270, which are flexible parts for vibrating, are individually or selectively provided with a driving unit 290.

The first flexible part 240, which is the flexible part for sensing provided with the sensing unit is disposed at an outer side in a displacement direction of the mass body part 210 depending on rotation of the mass body part 210.

That is, the first flexible part 240 is disposed at the outer side in the displacement direction of the mass body part 210 at the time of the rotation of the mass body part 210, such that the mass body part may be formed as largely as possible in the displacement direction (the Y axis direction), a maximum length (Lw2) is secured in the mass body part 210 as shown in FIG. 10, such that a maximum displacement is generated in the mass body part 210, thereby making it possible to improve sensing sensibility.

In addition, a connection direction in which the flexible part for sensing provided with the sensing unit 280 connects the mass body and the internal frame to each other may be in parallel with a connection direction in which the flexible part for vibrating provided with the driving unit 290 connects the internal frame and the external frame to each other.

That is, the first flexible part 240, which is the flexible part for sensing provided with the sensing unit 280 connects the mass body part 210 and the internal frame 220 to each other in a C1 direction corresponding to the X axis direction and the third flexible part 260 provided with the driving unit 290 connects the internal frame 220 and the external frame 230 to each other in a C2 direction corresponding to the X axis direction, such that the C1 direction corresponding to the connection direction of the first flexible part 240 and the C2 direction corresponding to the connection direction of the third flexible part 260 are in parallel with each other.

Next, the mass body part 210, which is displaced by Coriolis force, includes a first mass body 210a and a second mass body 210b and have the second flexible parts 250 connected thereto, respectively, so as to correspond to the centers of gravity of the first and second mass bodies 210a and 210b.

In addition, the first and second mass bodies 210a and 210b may have the same size.

Further, the first and second mass bodies 210a and 210b are connected to the internal frame 220 by the first and second flexible parts 240 and 250.

Here, the first and second flexible parts 240 and 250 connect the mass body part 210 to the internal frame 220 in the X axis direction. Further, in the Y axis direction, the first flexible parts 240 are connected to both end portions of the first and second mass body 210a and 210b, respectively, and the second flexible parts 250 are connected to central portions thereof, respectively.

Further, one end of the first flexible part 240 is connected to the mass body part 210 and the other end thereof is connected to the internal frame 220. To this end, the first flexible part 240 is extended in the X axis direction.

Through the above-mentioned configuration, the first and second mass bodies 210a and 210b are displaced based on the internal frame 220 by bending of the first flexible part 240 and twisting of the second flexible part 250 when Coriolis force acts thereon. Here, the first and second mass bodies 210a and 210b are rotated based on the X axis with respect to the internal frame 220.

Meanwhile, although the case in which the first and second mass bodies 210a and 210b have a generally square pillar shape is shown, the first and second mass bodies 210a and 210b are not limited to having the above-mentioned shape, but may have all shapes known in the art.

Further, the internal frame 220 supports the mass body part 210. More specifically, the internal frame 220 has the first and second mass bodies 210a and 210b positioned therein and is connected to the mass body part 210 by the first and second flexible parts 240 and 250. That is, the internal frame 220 allows a space in which the mass body part 210 may be displaced to be secured and becomes a basis when the mass body part 210 is displaced. In addition, the internal frame 220 may also cover only a portion of the mass body part 210.

Further, the sensing unit 280 and the driving unit 290 are formed on one surfaces of the first and third flexible parts 240 and 260, respectively, as an example.

Further, the internal frame 220 may be divided into two space parts 220a and 220b so that the first and second mass bodies 210a and 110b are positioned therein. In addition, the internal frame 220 may have a square pillar shape in which it has a square pillar shaped cavity formed at the center thereof, but is not limited thereto.

In addition, the internal frame 220 may include protrusion coupling parts 221 formed at both sides thereof so that the third flexible part 260, which is the flexible part for vibrating, is connected thereto, and the external frame 230 includes coupling protrusion parts 231 protruding toward the internal frame 220, that is, formed in parallel with the protrusion coupling parts of the internal frame, so that the third flexible part 260, which is the flexible part for vibrating, is connected thereto.

Further, one end of the third flexible part 260 is coupled to the protrusion coupling part 221 of the internal frame and the other end thereof is coupled to the coupling protrusion part 231 of the external frame. To this end, the third flexible part 260 is extended in the X axis direction.

More specifically, the protrusion coupling parts 221 of the internal frame are formed at both end portions of the internal frame in the X axis direction so as to be extended in the X axis direction in the Y axis direction, and the coupling protrusion parts 231 of the external frame 230 are extended toward the internal frame in the Y axis direction. In addition, the third flexible part 260 is disposed so that both end portions thereof in the X axis direction are coupled to the protrusion coupling part 21 and the coupling protrusion part 231.

Therefore, both of the first flexible part 240 provided with the sensing unit 280 and the third flexible part 260 provided with the driving unit 290 are disposed to be extended in the X axis direction. That is, a connection direction in which the first flexible part 240 connects the mass body part to the internal frame and a connection direction in which the third flexible part 260 connects the internal frame to the external frame are in parallel with each other.

In other words, the connection direction in which the first flexible part 240 connects the mass body part 210 to the internal frame 220, that is, the direction in which the first flexible part 240 is extended is in parallel with the connection direction in which the third flexible part 260 connects the internal frame 220 to the external frame 230, that is, the direction in which the third flexible part 260 is extended.

Further, the second and fourth flexible parts 250 and 270 are disposed in a direction in which they are perpendicular to each other.

As described above, since the first flexible part 240, the second flexible part 250, the third flexible part 260, and the fourth flexible part 270 of the angular velocity sensor 200 according to the second preferred embodiment of the present invention have the same shape as those of the first flexible part 140, the second flexible part 150, the third flexible part 160, and the fourth flexible part 170 of the angular velocity sensor 100 according to the first preferred embodiment of the present invention, a description thereof will be omitted.

Through the configuration as described above, in the angular velocity sensor 200 according to the second preferred embodiment of the present invention, the mass body part and the internal frame are connected to the external frame so as to be displaceable only in a specific direction, such that sensing may be accurately performed and the angular velocity rotated based on the X or Z axis may be measured by the sensing unit.

In addition, through the configuration as described above, in the angular velocity sensor 200 according to the second preferred embodiment of the present invention, the first flexible part 240 is disposed at the outer side of the mass body part in the displacement direction of the mass body part depending on the rotation of the mass body part 210, such that the mass body part may be designed at a maximum size in the Y axis direction when it is formed.

That is, since the mass body part is rotated based on the X axis and is displaced in the Y axis direction, a size of the mass body part in the Y axis direction as large as possible should be secured in order to generate a maximum displacement. In this case, sensing sensitivity is improved. Therefore, the angular velocity sensor 200 according to the second preferred embodiment of the present invention may improve the sensing sensitivity through optimal structures and organic couplings of the first flexible part 240, the mass body part 210, and the internal frame 220 described above.

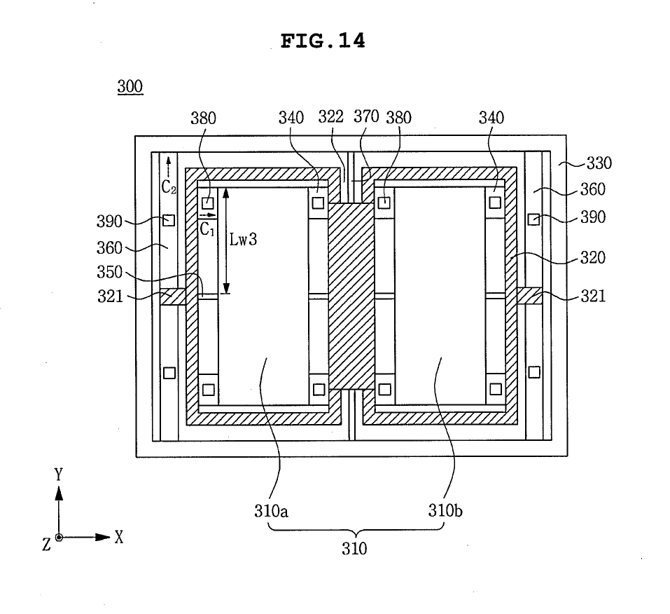

FIG. 14 is a plan view schematically showing an angular velocity sensor according to a third preferred embodiment of the present invention.

As shown in FIG. 14, the angular velocity sensor 300 according to the third preferred embodiment of the present invention is different only in an organic coupling between a mass body part and a first flexible part from the angular velocity sensor 100 according to the first preferred embodiment of the present invention. That is, in the angular velocity sensor 300 according to the third preferred embodiment of the present invention and the angular velocity sensor 100 according to the first preferred embodiment of the present invention, specific shapes, organic couplings and generation of displacements depending on them, and methods of sensing the displacements of remaining components are the same as each other.

More specifically, the angular velocity sensor 300 is configured to include a mass body part 310, an internal frame 320, an external frame 330, first flexible parts 340, second flexible parts 350, third flexible parts 360, and fourth flexible parts 370.

In addition, the first and second flexible parts 340 and 350, which are flexible parts for sensing, are individually or selectively provided with a sensing unit 380, and the third and fourth flexible parts 360 and 370, which are flexible parts for vibrating, are individually or selectively provided with a driving unit 390.

In addition, the flexible part for vibrating provided with the driving unit 390 is disposed at an outer side in a displacement direction of the mass body part 310 depending on rotation of the mass body part 310, and the flexible part for sensing provided with the sensing unit 380 is disposed at an outer side in the displacement direction of the mass body part depending on the rotation of the mass body part.

That is, the first flexible part 340, which is the flexible part for sensing, is disposed at the outer side in the displacement direction of the mass body part 310 depending on the rotation of the mass body part 310, such that it may be formed as largely as possible in the displacement direction (the Y axis direction) of the mass body part.

In addition, the third flexible part 360, which is the flexible part for vibrating provided with the driving unit 390, is disposed at the outer side of the internal frame in the displacement direction of the mass body part depending on the rotation of the mass body part. That is, as described above with reference to the enlarged view of FIG. 2, the third flexible part 360 is disposed at the outer side of the internal frame in the displacement direction of the mass body 310, such that the internal frame 320 may be formed as largely as possible in the displacement direction (the Y axis direction) of the mass body part and a maximum length Lw3 of the mass body part 310 from the center of rotation may be secured. Therefore, a maximum displacement is generated in the mass body 310, thereby making it possible to improve the sensing sensibility.

In addition, a connection direction C1 in which the first flexible part 340 corresponding to the flexible part for sensing provided with the sensing unit 380 connects the mass body part 310 and the internal frame 320 to each other may be perpendicular to a connection direction C2 in which the third flexible part 360 corresponding to the flexible part for vibrating provided with the driving unit connects the internal frame 320 and the external frame 330 to each other.

In addition, the first and second flexible parts 340 and 350 connect the mass body part 310 to the internal frame 320 in the X axis direction. Further, in the Y axis direction, the first flexible parts 340 are connected to both end portions of the first and second mass body 310a and 310b, respectively, and the second flexible parts 350 are connected to central portions thereof, respectively.

Further, one end of the first flexible part 340 is connected to the mass body part 310 and the other end thereof is extended in the X axis direction so as to be connected to the internal frame 320.

In addition, since the first flexible part 340, the second flexible part 350, the third flexible part 360, the fourth flexible part 370, and a protrusion coupling part 321 of the angular velocity sensor 300 according to the third preferred embodiment of the present invention have the same shape as those of the first flexible part 140, the second flexible part 150, the third flexible part 160, the fourth flexible part 170, and the protrusion coupling part 121 of the angular velocity sensor 100 according to the first preferred embodiment of the present invention, a description thereof will be omitted.

According to the preferred embodiments of the present invention, it is possible to provide an angular velocity sensor capable of removing interference between a driving mode and a sensing mode and decreasing an effect due to a manufacturing error by driving a frame and a mass body by a single driving part to individually generate driving displacement and sensing displacement of the mass body and forming flexible parts so that the mass body is movable only in a specific direction and capable of improving sensitivity by maximizing a mass body part in a limited region due to an optimal structure.

Although the preferred embodiment of the present invention has been disclosed for illustrative purposes, it will be appreciated that the present invention is not limited thereto, and those skilled in the art will appreciate that various modifications, additions and substitutions are possible, without departing from the scope and spirit of the invention. Particularly, the present invention has been described based on the “X axis”, the “Y axis”, and the “Z axis”, which are defined for convenience of explanation. Therefore, the scope of the present invention is not limited thereto.

Accordingly, any and all modifications, variations or equivalent arrangements should be considered to be within the scope of the invention, and the detailed scope of the invention will be disclosed by the accompanying claims.

What is claimed is:

1. An angular velocity sensor comprising:
a mass body part including a plurality of mass bodies;
an internal frame supporting the mass body part;
a flexible part for sensing connecting the mass body part to the internal frame so that the mass body part is rotatable and provided with a sensing unit;
an external frame supporting the internal frame; and
a flexible part for vibrating connecting the internal frame to the external frame so that the internal frame is rotatable and provided with a driving unit,
wherein the flexible part for vibrating provided with the driving unit is disposed at an outer side of the internal frame in a displacement direction of the mass body part depending on rotation of the mass body part.

2. The angular velocity sensor as set forth in claim 1, wherein a connection direction in which the flexible part for sensing provided with the sensing unit connects the mass body and the internal frame to each other is in parallel with a connection direction in which the flexible part for vibrating provided with the driving unit connects the internal frame and the external frame to each other.

3. The angular velocity sensor as set forth in claim 1, wherein the flexible part for sensing includes first and second flexible parts connecting the mass body part to the internal frame, respectively, the first and second flexible parts being disposed in a direction in which they are perpendicular to each other.

4. The angular velocity sensor as set forth in claim 3, wherein the first flexible part is a beam having a surface formed by one axis direction and the other axis direction and a thickness extended in a direction perpendicular to the surface.

5. The angular velocity sensor as set forth in claim 4, wherein the first flexible part is a beam having a predetermined thickness in a Z axis direction and a surface formed by X and Y axes and has a width W1 in an X axis direction larger than a thickness T1 in the Z axis direction.

6. The angular velocity sensor as set forth in claim 3, wherein the second flexible part is a hinge having a thickness in one axis direction and a surface formed in the other axis direction.

7. The angular velocity sensor as set forth in claim 6, wherein the second flexible part is a hinge having a predetermined thickness in a Y axis direction and a surface formed in X and Z axes and has a width W2 in a Z axis direction larger than a thickness T2 in the Y axis direction.

8. The angular velocity sensor as set forth in claim 3, wherein one surfaces of the first and second flexible parts are individually or selectively provided with the sensing unit sensing a displacement of the mass body.

9. The angular velocity sensor as set forth in claim 1, wherein the flexible part for vibrating includes third and fourth flexible parts connecting the internal frame to the external frame, respectively, and
a connection direction in which the third flexible part connects the internal frame to the external frame and a connection direction in which the fourth flexible part connects the internal frame to the external frame are in parallel with each other.

10. The angular velocity sensor as set forth in claim 9, wherein the third flexible part is a beam having a surface formed by one axis direction and the other axis direction and a thickness extended in a direction perpendicular to the surface.

11. The angular velocity sensor as set forth in claim 10, wherein the third flexible part is a beam having a predetermined thickness in a Z axis direction and a surface formed by X and Y axes and has a width W3 in an X axis direction larger than a thickness T3 in the Z axis direction.

12. The angular velocity sensor as set forth in claim 9, wherein the fourth flexible part is a hinge having a thickness in one axis direction and a surface formed in the other axis direction.

13. The angular velocity sensor as set forth in claim 12, wherein the fourth flexible part is a hinge having a predetermined thickness in an X axis direction and a surface formed in Y and Z axes and has a width W4 in a Z axis direction larger than a thickness T4 in the X axis direction.

14. The angular velocity sensor as set forth in claim 13, wherein the fourth flexible part is connected to a central portion of the internal frame, and the internal frame is rotated so that a symmetrical displacement is generated based on the fourth flexible part.

15. The angular velocity sensor as set forth in claim 9, wherein one surfaces of the third and fourth flexible parts are individually or selectively provided with the driving unit driving the internal frame.

16. The angular velocity sensor as set forth in claim 1, wherein the mass body part includes first and second mass bodies disposed to be symmetrical to each other.

17. The angular velocity sensor as set forth in claim 16, wherein the first and second mass bodies supported by the internal frame are disposed to be symmetrical to each other based on the fourth flexible part connected to the internal frame.

18. The angular velocity sensor as set forth in claim 1, wherein the internal frame includes protrusion coupling parts protruding toward the external frame so that the flexible parts for sensing provided with the sensing unit are connected thereto.

19. The angular velocity sensor as set forth in claim 17, wherein the protrusion coupling parts are formed at both end portions of the internal frame so as to be extended in an X axis, and the flexible parts for sensing are coupled to the protrusion coupling parts in a Y axis direction.

20. An angular velocity sensor comprising:
a mass body part including a plurality of mass bodies;
an internal frame supporting the mass body part;
a flexible part for sensing connecting the mass body part to the internal frame so that the mass body part is rotatable and provided with a sensing unit;
an external frame supporting the internal frame; and
a flexible part for vibrating connecting the internal frame to the external frame so that the internal frame is rotatable and provided with a driving unit,
wherein the flexible part for sensing provided with the sensing unit is disposed at an outer side in a displacement direction of the mass body part depending on rotation of the mass body part.

21. The angular velocity sensor as set forth in claim 20, wherein a connection direction in which the flexible part for sensing provided with the sensing unit connects the mass body and the internal frame to each other is in parallel with a connection direction in which the flexible part for vibrating provided with the driving unit connects the internal frame and the external frame to each other.

22. The angular velocity sensor as set forth in claim 20, wherein the internal frame includes protrusion coupling parts protruding toward the external frame so that the flexible parts for sensing provided with the sensing unit are connected thereto, the external frame includes coupling protrusion parts formed so as to be in parallel with the protrusion coupling parts of the internal frame, and one end of the flexible part for vibrating provided with the driving unit is connected to the protrusion coupling part and the other end thereof is connected to the coupling protrusion part.

23. The angular velocity sensor as set forth in claim 20, wherein the flexible part for sensing includes first and second flexible parts connecting the mass body part to the internal frame, respectively, and
a connection direction in which the first flexible part connects the internal frame to the mass body part is in parallel with a connection direction in which the second flexible part connects the internal frame to the mass body part.

24. The angular velocity sensor as set forth in claim 23, wherein each of the first and second flexible parts connects the mass body part to the internal frame in an X axis direction, and the mass body part has the first flexible parts connected to both end portions thereof, respectively, and the second flexible parts connected to central portions thereof, respectively, in a Y axis direction.

25. The angular velocity sensor as set forth in claim 20, wherein the flexible part for vibrating includes third and fourth flexible parts connecting the internal frame to the external frame, respectively, and
a connection direction in which the third flexible part connects the internal frame to the external frame and a connection direction in which the fourth flexible part connects the internal frame to the external frame are perpendicular to each other.

26. An angular velocity sensor comprising:
a mass body part including a plurality of mass bodies;
an internal frame supporting the mass body part;
a flexible part for sensing connecting the mass body part to the internal frame so that the mass body part is rotatable and provided with a sensing unit;
an external frame supporting the internal frame; and
a flexible part for vibrating connecting the internal frame to the external frame so that the internal frame is rotatable and provided with a driving unit,
wherein the flexible part for vibrating provided with the driving unit is disposed at an outer side in a displacement direction of the mass body part depending on rotation of the mass body part, and the flexible part for sensing provided with the sensing unit is disposed at the outer side in the displacement direction of the mass body part depending on the rotation of the mass body part.

27. The angular velocity sensor as set forth in claim 26, wherein a connection direction in which the flexible part for sensing provided with the sensing unit connects the mass body part and the internal frame to each other is perpendicular to a connection direction in which the flexible part for vibrating provided with the driving unit connects the internal frame and the external frame to each other.

28. The angular velocity sensor as set forth in claim 26, wherein the flexible part for sensing includes first and second flexible parts connecting the mass body part to the internal frame, respectively, and
a connection direction in which the first flexible part connects the internal frame to the mass body part is in parallel with a connection direction in which the second flexible part connects the internal frame to the mass body part.

29. The angular velocity sensor as set forth in claim 28, wherein each of the first and second flexible parts connects the mass body part to the internal frame in an X axis direction, and the mass body part has the first flexible parts connected to both end portions thereof, respectively, and the second flexible parts connected to central portions thereof, respectively, in a Y axis direction.

30. The angular velocity sensor as set forth in claim 26, wherein the flexible part for vibrating includes third and fourth flexible parts connecting the internal frame to the external frame, respectively, and
a connection direction in which the third flexible part connects the internal frame to the external frame and a connection direction in which the fourth flexible part connects the internal frame to the external frame are in parallel with each other.
